(19) United States
(12) Patent Application Publication
(10) Pub. No.: US 2017/0170918 A1
(43) Pub. Date: Jun. 15, 2017

(54) RECEIVER DEVICE WITH ADJUSTABLE DELAY AND EVENT NOTIFICATION

(71) Applicant: Adaptive Sound Technologies, Inc., San Jose, CA (US)

(72) Inventors: Sam J. Nicolino, JR., Cupertino, CA (US); Ira Chayut, Los Gatos, CA (US); Charles Edward Gibson, Campbell, CA (US)

(21) Appl. No.: 14/966,963

(22) Filed: Dec. 11, 2015

(51) Int. Cl. H04H 20/18; H04L 29/06; H04W 4/22

(52) U.S. Cl. CPC H04H 20/18; H04W 4/22; H04L 65/4076

(57) ABSTRACT

First and second receiver devices can receive different information, such as audio and video information, from the same source and corresponding to the same event. In an example that includes radio (audio only) and video broadcasts, the received audio broadcast information can be delayed relative to the received video broadcast information. An audio signal delay circuit can be configured to receive and delay reproduction of the audio broadcast information, such as based on a user-specified delay parameter. In an example, a processor circuit monitors the audio information in real-time for a specified event, such as an emergency alert, and notifies the listener substantially without delay.

### CLAIM OF PRIORITY

This application claims the benefit of priority under 35 U.S.C. §119(e) of U.S. Provisional Patent Application Ser. No. 62/091,135, filed on Dec. 12, 2014, which is incorporated herein by reference in its entirety.

### BACKGROUND

Multiple signals originating from a common source can be received at a destination at different times depending on, among other things, the distance between the source and destination, and the respective different mediums used to transmit the multiple signals. For example, news coverage of a live event occurring at a stadium, such as a sporting event, can be broadcast from the live event's location. At a destination receiver device, such as in a person's home that is remote from the stadium, the news coverage can be received via the internet, via a television signal received using an antenna, via a television signal received using a satellite, cable, or other dedicated connection, or via radio (e.g., AM or FM band), among other ways. The arrival times at the destination location for any one or more of the internet, television, and radio signals can be different.

In an example, a person listening to audio from a local radio broadcast of a sporting event may also watch the same sporting event on television, such as with the television sound muted. Due to the scenario described above, there can be a time difference between the broadcast signals received via radio and via television, which can be annoying or confusing to the listener/viewer. Elliott et al., in U.S. Pat. No. 7,280,813, titled “Variable Delay Radio Receiver”, refers to a radio receiver with a variable delay for matching audio from a radio broadcast of a live event with a video stream from the same live event.

### OVERVIEW

The present inventors have recognized, among other things, that a problem to be solved can include providing a playback device that can reproduce audio using a specified delay and can monitor one or more input channels in real-time for one or more specified audio signatures and/or emergency signals. In an example, a playback device including a radio receiver can reproduce audio using a specified delay, and can be used to play audio for a particular event. A television, such as tuned to a broadcast of the same particular event, can be used in coordination with the playback device. Generally, a televised event is subject to a greater broadcast delay than a radio broadcast of the same event, and the specified delay for the radio can be adjusted by a user of the playback device to temporally coordinate the radio broadcast replay with the “live” televised broadcast.

In an example, in response to a specified audio signature and/or emergency signal being received and identified in the real-time radio signal, the playback device can provide an audible and/or visual alert to a user, such as substantially in real-time with its receipt.

In an example, the playback device can be configured to recognize similar features in audio signals received from multiple different sources. The features can be used to automatically identify a time delay amount, and at least one of the received audio signals can be delayed by the identified time delay amount before the at least one of the signals is played back or is made available at an output of the device.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates generally an example that includes multiple different means for broadcasting a live event or an emergency alert.

FIG. 2 illustrates generally an example of a variable delay radio receiver with emergency alert and audio signature identification functions.

FIG. 3 illustrates generally an example of a method that includes synchronizing a radio delay with a video broadcast.

FIG. 4 illustrates generally an example of a method that includes monitoring a real-time signal for an audio signature or emergency signal.

FIG. 5 illustrates generally an example of a system that includes a radio receiver and a remote control for interfacing with the radio receiver.

FIG. 6 illustrates generally an example of a system that includes a radio receiver and a delay circuit.

FIG. 7 illustrates generally an example that includes automatically synchronizing audio signals using audio signal waveform characteristics.

### DETAILED DESCRIPTION

This detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. The present inventors contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.”

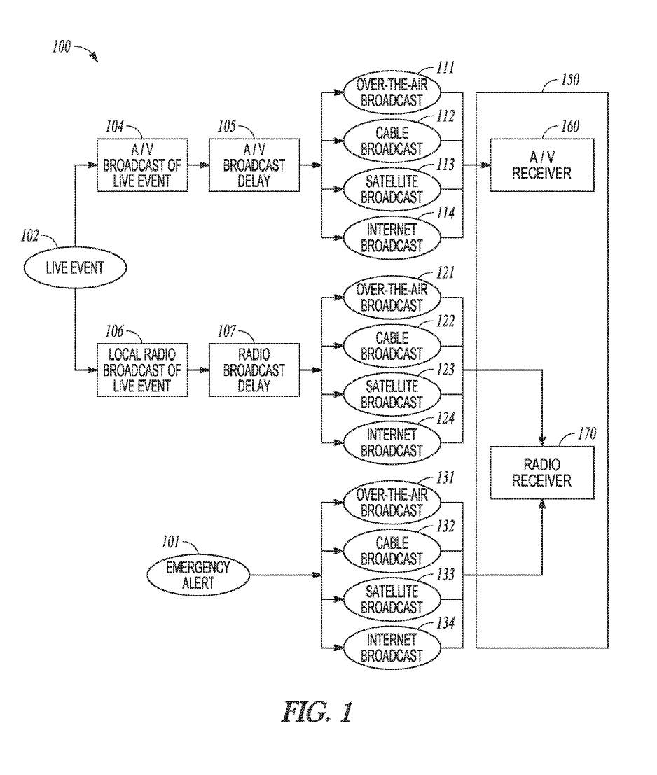

FIG. 1 illustrates generally an example 100 that includes distributing media using multiple different channels. The example 100 includes a live event 102, and information about the live event 102 can be distributed or broadcast. In an example, the live event 102 includes a sporting event that can be televised or broadcast via AM or FM radio. At block 104, an audio and/or video (A/V) broadcast is initiated at or based on the live event 102. In an example, the A/V broadcast at 104 includes a television broadcast. The A/V broadcast about the live event 102 can be transmitted using one or more of multiple different media or means, including over-the-air wireless broadcast 111, cable or fiber optic broadcast 112, satellite broadcast 113, internet broadcast 114, or using some other means to distribute information about the live event 102.

A first A/V receiver 160 (e.g., a television receiver, a computer, a mobile device, etc.) can be configured to receive the A/V broadcast 104 and optionally to reproduce the broadcast material for one or more viewers or listeners. The A/V receiver 160 can reside at a first location 150 (e.g., a residence, a bar or restaurant, etc.). In an example, the A/V receiver 160 includes a conventional radio frequency broadcast receiver, a cable box, a set-top box, or other receiver that is configured to receive broadcast media. However, the different means of transmissions such as the over-the-air wireless broadcast 111, cable or fiber optic broadcast 112, satellite broadcast 113, or internet broadcast 114, among others, can have different respective transmission times and/or delay times and therefore can have different receiving times at the A/V receiver 160. For example, a broadcast signal “bouncing off” a satellite may be delayed by several seconds between the live event 102 and the broadcast coverage of the live event 102 that is received by the A/V receiver 160. A cable or internet broadcast delay can be shorter or longer than the satellite broadcast delay.

The radio broadcast 106 can optionally be transmitted to and received by a second A/V receiver. In the example of FIG. 1, the second A/V receiver is represented by a radio receiver 170. Optionally, some other receiver such as a computer or mobile device can be used. The radio broadcast 106 can be received via one or more of an over-the-air wireless broadcast 121, cable or fiber optic broadcast 122, satellite broadcast 123, internet broadcast 124, or other means. In an example, a transmission of the radio broadcast 106 over-the-air 121 can reach the radio receiver 170 at the same first location 150 as the A/V receiver 160, such as a few seconds after the radio signals are broadcast from the live event 102. In an example, the radio broadcast 106 can arrive at the radio receiver 170 before a corresponding portion of the A/V broadcast 104. The audio from the radio receiver 170 may not correspond to or coincide with an image or audio provided at the A/V receiver 160 because of the different delays associated with the different transmission media.

In an example, video and audio signals originating at the live event 102 can be separately received at one or more playback (or re-transmission) devices using the internet. The video and audio signals can optionally originate from different hosts or web sites, and data packets corresponding to the video and audio signals may travel different paths to reach the one or more playback devices. At least because of the different origination points and/or travel paths, these data packets or signals from different hosts or web sites can have different delay times with respect to the live event 102.

Additionally to any delay or transmission time inherent in the different means of transmissions (i.e., 111-114 and 121-124), the A/V broadcast can be subject to an added A/V broadcast delay 105, such as a TV broadcast delay, or the radio broadcast 106 can be subject to a radio broadcast delay 107. TV or radio broadcasters generally delay live transmissions for at least several seconds to allow broadcasters to catch and squelch errors, profanity, or to otherwise filter a broadcast signal.

In an example, the radio receiver 170 can include a programmable delay feature that can be adjusted by a user, or can be adjusted automatically by a controller integrated with the radio receiver 170, to synchronize audio that is replayed using the radio receiver 170 with another signal, such as the signal from the A/V broadcast 104. In an example, the programmable delay can enable synchronization between (1) audio playback from a radio transmission of a sporting event and (2) a live video stream of the same sporting event being watched on a television set, computer, portable device, etc. In an example, the radio receiver 170 includes a hardware or software button that can be actuated by a user to step the time delay up or down to adjust the delay amount.

The example 100 of FIG. 1 includes an emergency alert 101 that can be transmitted via over-the-air wireless broadcast 131, cable or fiber optic broadcast 132, satellite broadcast 133, internet broadcast 134, or via other means. Conventionally, emergency alert signals are transmitted via over-the-air wireless broadcast 131. In an example, the emergency alert 101 can be broadcast using ultrasonic transmission means, such as in a hospital or other critical care environment. The emergency alert 101 can include, for example, a message from the Emergency Alert System (EAS) in the United States. EAS messages can be transmitted using AM, FM, broadcast television, cable television and Land Mobile Radio Service, VHF, UHF, and FiOS (wireline video providers), and can be transmitted using digital or satellite television or radio (e.g., using DirecTV, Dish Network, Sirius XM satellite radio, IBOC, DAB, and others). In an example, the emergency alert 101 information can be received at a receiver device, such as the radio receiver 170, and the alert can be reproduced for a listener.

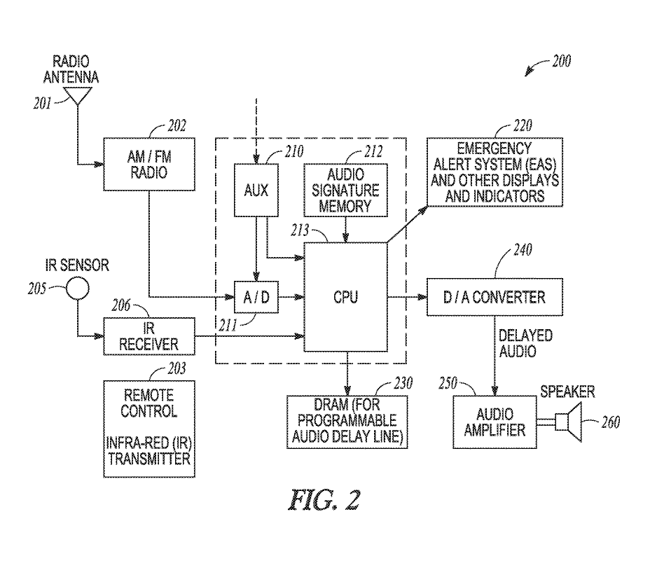

FIG. 2 illustrates generally an example of a variable delay radio system 200 with emergency alert and audio signature identification functions. In an example, the radio receiver 170, from the example of FIG. 1, includes the variable delay radio system 200. The radio system 200 includes generally an input stage, a processing and delay stage, and an output stage. The input stage receives an input signal via a wired or wireless input. In an example, the input stage receives a broadcast signal, such as via an over-the-air wireless broadcast, a cable or fiber optic broadcast, a satellite broadcast, an internet broadcast, or via other means. The processing and delay stage can include analog and/or digital circuitry to sample and hold a portion of the broadcast signal for a duration, and that duration can be set automatically or by a user. The output stage can include an audio signal output that provides the held portion of the broadcast signal and optionally reproduces the signal via a loudspeaker.

The system 200 includes an antenna 201, such as for receiving AM and/or FM radio frequency signals from a local or remote radio station. In an example, the system 200 includes an input port for receiving information via a physical cable, such as an electrical or optical cable. In another example, the antenna 201 is configured for receiving radio signals other than in the AM and FM radio bands. In the example of FIG. 2, the antenna 201 is coupled to an AM/FM radio receiver 202 configured to process the received radio signals and to provide an electrical signal representing the audio of a radio broadcast. The AM/FM radio receiver 202 can be configured to receive digital or analog radio signals, and can be configured to include or use program information or other information with the audio signal. Signals from the AM/FM radio receiver 202 can be provided to an analog-to-digital (A/D) converter 211 which, in turn, can provide a digital representation of all or a portion of a signal from the receiver 202. The A/D converter 211 can operate at a rate set by a processor circuit 213.

The system 200 includes an auxiliary input 210 configured to receive an audio signal from an external source. In an example, the external source can include a broadcast radio tuner, an A/V receiver, a television receiver, an internet radio tuner or other source of streaming audio, or other device configured to provide an audio signal. In an example, the auxiliary input 210 includes or is coupled to a microphone that is configured to sense audio information from the operating environment of the system 200.

The auxiliary input 210 can be configured to receive a digital or analog audio signal. If an analog audio signal is received by the auxiliary input 210, then the analog audio signal can be passed to the A/D converter 211 for conversion to the digital domain. If a digital audio signal is received by the auxiliary input 210, then the digital audio signal can bypass the A/D converter 211 and instead feed directly to the processor circuit 213.

The system 200 can be configured to receive and process multiple different audio signals or channels, such as substantially simultaneously. Optionally, each of the multiple channels is processed independently of the others. In an example, the AM/FM radio receiver 202 and/or the auxiliary input 210 can each be configured to receive at least two channels of audio information. The A/D converter 211 can be configured to receive and process audio information from each of the channels from each of the sources. The processor circuit 213 can be configured to selectively delay one or more channels of audio information. In an example, the processor circuit 213 can be configured to independently delay each of the multiple channels of audio information by different respective delay durations, or can be configured to pass the audio information from one or more channels or inputs without delay.

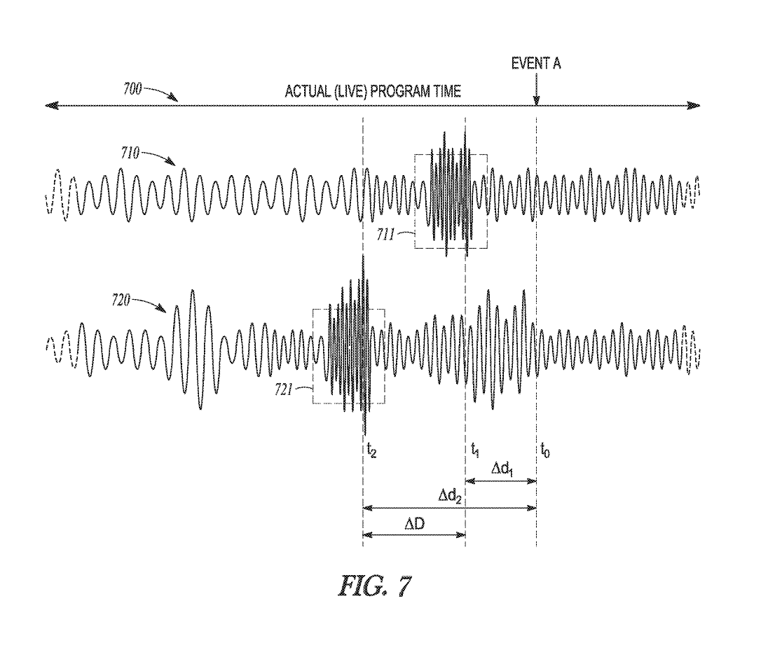

In an example that includes receiving multiple audio signal channels, the system 200 can be configured to synchronize the multiple channels based on a user input that specifies a delay characteristic to apply to one or more of the channels with respect to the others. The system 200 can additionally or alternatively be configured to automatically synchronize the multiple channels based on one or more features of the respective audio signals, or based on a time code signal that accompanies one or more of the audio channels. FIG. 7, discussed below, illustrates generally an example that includes automatically synchronizing audio signals from different sources based on features of the respective audio signals. The same or similar principles can be applied to automatically synchronize audio signals corresponding to multiple channels from a single source.

In an example that includes receiving multiple audio signal channels, the system 200 can be configured to dynamically update or adjust a delay for one or more of the channels. A delay update or adjustment can be triggered by a feature of one or more of the audio signals, or the delay update or adjustment can be triggered by some external event. For example, information received from a sensor, such as communicatively coupled to the system 200, can trigger the update or adjustment. In an example, the sensor includes a microphone or an accelerometer, and the system 200 can update or adjust a delay for one or more of the audio channels based on a change or trend in a signal received from the microphone or from the accelerometer. In an example, different audio channels receive different respective delay changes in response to different triggers or inputs.

Referring again to FIG. 2, the processor circuit 213 can include a microprocessor, a digital signal processor, or the like. The digital signal from the A/D converter 211 can be sampled by the processor circuit 213 and stored in a buffer and/or a memory circuit 230 (e.g., DRAM, SDRAM, etc.), such as according to a user setting that indicates a desired or default delay parameter or duration.

The processor circuit 213 can be configured to provide an output rate clock signal to a digital-to-analog (D/A) converter 240. The D/A converter 240 can be configured to drive an audio output stage of the system 200, such as to reproduce, with a specified delay, a radio (or other) signal received by the system 200. For example, the D/A converter 240 can be configured to provide the delayed audio signal to an audio amplifier 250 and a speaker 260. The A/D converter 211 can include an anti-aliasing filter and the D/A converter 240 can include a reconstruction filter.

The system 200 can include an IR sensor 205 and an IR receiver circuit 206. The IR sensor 205 and IR receiver circuit 206 can be configured to receive control signals from a remote control device 203. The received control signals can be passed to the processor circuit 213 for controlling various aspects of the system 200, such as a delay duration amount. The system 200 can include one or more other hardware or software inputs to receive information from a user about a delay duration to apply to a received audio signal.

The system 200 can include an audio signature memory circuit 212. The audio signature memory circuit 212 can include information about one or more audio signatures that can be identified in a received audio signal, such as from the A/D converter 211 or from the radio receiver 202. In an example, an audio signature, such as can be stored in the audio signature memory circuit 212, includes information about one or more of an amplitude, duration, frequency content, profile, spectral characteristic, timing characteristic, waveform shape, or other feature of an audio signal, such as in analog or in digital form.

In an example, an audio signature includes a set of rules for determining when a specified audio signature is identified. For example, an audio signature can include an amplitude rule that states that if an amplitude of a received radio signal exceeds a specified threshold amplitude for greater than a specified duration, then the processor circuit 213 can be configured to issue an alert. In an example, the amplitude rule can be associated with a particular frequency band. In an example, the processor circuit 213 can be configured to filter received signal information to distinguish between relevant signal information and noise or other signal artifacts.

In an example, the processor circuit 213 can be configured to recognize an emergency alert signal in a received signal, such as in a received AM or FM radio broadcast signal. Information about multiple different emergency alert signals can be stored in the audio signature memory circuit 212. The processor circuit 213 can be configured to recognize a particular one of the multiple different emergency alert signals in a received radio signal by comparing a received signal to the signal information stored in the audio signature memory circuit 212. In response to identifying an emergency alert signal in a received radio signal, the processor circuit 213 can provide an emergency alert signal to the D/A converter 240, such as without delay. In an example, the processor circuit 213 responds to an identified emergency alert signal by initiating an audible alert. In an example, the processor circuit 213 responds to the identified emergency alert by additionally or alternatively providing a visual alert using an emergency alert indicator 220. The emergency alert indicator 220 can include, among other things, a light (e.g., an LED), a dedicated speaker (e.g., a buzzer), or one or more other devices configured to visually or audibly attract a user's attention.

In an example, the emergency alert indicator 220 can be configured to operate (e.g., by flashing a light or sounding an alarm) nearly immediately after the receipt of an emergency alert. In an example, a substantially real-time, or non-delayed, alert sound or tone can be introduced into the delayed audio stream. For example, the processor circuit 213 can be used to interject an alert signal substantially in real-time to the D/A converter 240, such as in response to a detected noise or frequency signature that is detected in the radio signal.

In an example, the processor circuit 213 can be configured to monitor a received audio signal for other, non-emergency audio signal characteristics. For example, the processor circuit 213 can be configured to monitor a received audio signal for relatively drastic increases in signal amplitude. In an example that includes a radio broadcast of a sporting event, an increase in a radio audio signal amplitude can correspond to a crowd cheering or booing. If the processor circuit 213 detects such an increase in amplitude, then the emergency alert indicator 220 can be activated. For example, a light and/or non-delayed sound or tone can be used to alert or advise the listener to watch a TV screen, as something notable may be happening and will soon be presented on the relatively-delayed TV.

In an example, sports radio listeners may tune into a game on a radio while doing something else, like browsing the internet, working, or performing other tasks. Using the systems described herein, when something noteworthy happens in the game, the listener would be forewarned to turn his or her attention to a television broadcast of the same game. That is, the radio device can be configured to provide an “early warning” that something exciting is about to happen. In some examples, a listener can be listening to a game on a radio while watching something other than the same game on a TV. In response to the alert, the listener could change the channel to see the noteworthy event. In this example, the system 200 may be operated with the emergency alert indicator 220 and without audio reproduction of the game.

In an example, the emergency alert indicator 220 can be configured to flash a light or insert a non-delayed sound or tone into the delayed audio stream (e.g., using the processor circuit 213 to interject a signal substantially in real-time to the D/A converter 240) in response to an audio profile of the real-time signal that indicates a break, commercial, or other event. In an example that includes a radio broadcast of a sporting event, the audio profile can indicate a time-out or an “unexciting” event from the perspective of a sports-radio listener. In this scenario, the listener can be notified by the emergency alert indicator 220 that it may be a convenient time to take a bathroom break or otherwise to tune out of the broadcast with a low risk of missing an important or noteworthy event. In an example, the audio profile can indicate that the real-time signal of the tuned station has gone on a commercial break. Because the listener is receiving the audio signal with a delay (e.g., 10-15 seconds), the commercial break can indicate that nothing noteworthy is likely to happen in the delay period, and it may be a convenient time for the listener to tune out or step away from the radio.

If an emergency alert system (EAS) message is received and identified in the radio signal (e.g., using the audio signature memory circuit 212 and the processor circuit 213), a visual notification can be provided to a user by the emergency alert indicator 220. In an example, the visual notification includes a light or other visual cue. In an example, the light can be the same light as described above to indicate a noteworthy event, or the light can be a different light (e.g., a differently colored light). If the same light is used, then the light can flash according to a first pattern for the noteworthy event, and the light can flash according to a second pattern for the EAS message. In response to a received and identified EAS message, the delayed audio can be “short circuited”, and the emergency broadcast information can be fed directly to the listener, for example, using the audio amplifier 250 and the speaker 260.

Handling an EAS message in this manner can be advantageous because a listener can timely receive important emergency information even when he or she is listening to a delayed program. In some examples, a television's audio may be turned off and the user may not be looking at the television screen when an emergency notification is given. Providing the EAS to the user without delay, such as by bypassing an audio delay circuit, can ensure that the user will receive the emergency signal as timely as possible.

In an example, only a specified subset of EAS messages can be reported using the system 200. For example, test and administrative messages may not be handled specially and, for example, only one or more the following messages would be treated as emergencies: {“AVA”, “Avalanche Watch”}, {“AVW”, “Avalanche Warning”}, {“BZW”, “Blizzard Warning”}, {“CAE”, “Child Abduction Emergency”}, {“CDW”, “Civil Danger Warning”}, {“CEM”, “Civil Emergency Message”}, {“CFA”, “Coastal Flood Watch”}, {“CFW”, “Coastal Flood Warning”}, {“DSW”, “Dust Storm Warning”}, {“EAN”, “Emergency Action Notification”}, {“EAT”, “Emergency Action Termination”}, {“EQW”, “Earthquake Warning”}, {“EVI”, “Evacuation Immediate”}, {“FFA”, “Flash Flood Watch”}, {“FFS”, “Flash Flood Statement”}, {“FFW”, “Flash Flood Warning”}, {“FLA”, “Flood Watch”}, {“FLS”, “Flood Statement”}, {“FLW”, “Flood Warning”}, {“FRW”, “Fire Warning”}, {“HLS”, “Hurricane Statement”}, {“HMW”, “Hazardous Materials Warning”}, {“HUA”, “Hurricane Watch”}, {“HUW”, “Hurricane Warning”}, {“HWA”, “High Wind Watch”}, {“HWW”, “High Wind Warning”}, {“LAE”, “Local Area Emergency”}, {“LEW”, “Law Enforcement Warning”}, {“NIC”, “National Information Center”}, {“NUW”, “Nuclear Power Plant Warning”}, {“RHW”, “Radiological Hazard Warning”}, {“SMW”, “Special Marine Warning”}, {“SPS”, “Special Weather Statement”}, {“SPW”, “Shelter in Place Warning”}, {“SVA”, “Severe Thunderstorm Watch”}, {“SVR”, “Severe Thunderstorm Warning”}, {“SVS”, “Severe Weather Statement”}, {“TOA”, “Tornado Watch”}, {“TOE”, “911 Telephone Outage Emergency”}, {“TOR”, “Tornado Warning”}, {“TRA”, “Tropical Storm Watch”}, {“TRW”, “Tropical Storm Warning”}, {“TSA”, “Tsunami Watch”}, {“TSW”, “Tsunami Warning”}, {“VOW”, “Volcano Warning”}, {“WSA”, “Winter Storm Watch”}, or {“WSW”, “Winter Storm Warning”}.

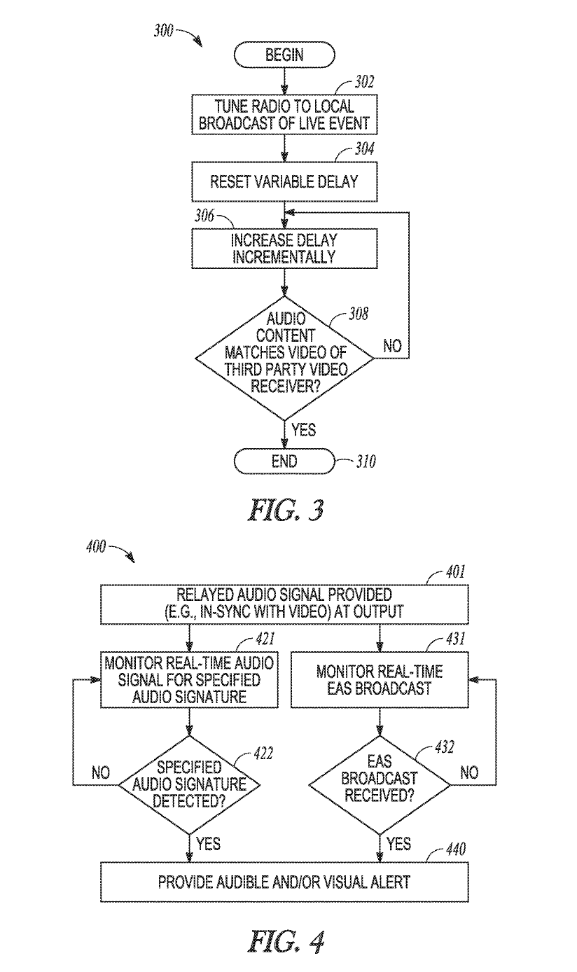

FIG. 3 illustrates generally an example of a method 300 that includes synchronizing a radio delay with a video broadcast. In an example, a user can operate the system 200 according to the method 300 to synchronize reproduction of a first broadcast signal with reproduction of a relatively-delayed second broadcast signal. In an example, the first broadcast signal is an AM or FM radio broadcast signal, and the second signal is a television broadcast or internet stream signal. The user can operate the system 200 by adjusting a delay parameter such that reproduction of an audio signal from the first broadcast corresponds in time with reproduction of a video signal from the second broadcast. In an example, the second broadcast signal can be similarly delayed, such as using a system configured to delay reproduction of video signals.

In the example of FIG. 3, at 302, a listener watching a live event on a television can tune the radio receiver 202 of the system 200 to a station that is broadcasting the same live event. In this example, both the television and the radio receiver can be located at the same location or residence. Optionally, at 304, the listener can reset a variable delay parameter of the system 200 (e.g., to no delay).

At 306, the listener can incrementally increase the time delay using a delay input to the system 200. In an example, the delay input is a hardware button or a button implemented in software that is operable by a user. In response to actuation of the button, or other input indicating a change to the delay parameter, the processor circuit 213 adjusts a delay characteristic of the received audio signal.

At 308, the listener can determine whether the content of the first (e.g., radio) broadcast audio sufficiently matches or corresponds to the second (e.g., televised video) broadcast. If the second broadcast lags behind the audio of the first broadcast, then the listener can increase the variable time delay at 306. At 310, when the user is satisfied with the timing relationship between the first and second broadcast signals, the live event can be enjoyed by the listener without further changes to the system 200.

FIG. 4 illustrates generally an example of a method 400 that includes monitoring a real-time signal for an audio signature or emergency signal. Optionally, at 401, the method 400 follows item 310 in the example of FIG. 3. At 401, for example, a delayed audio signal can be provided, and the delayed audio signal can be substantially synchronized with a video signal (e.g., by a user using the system 200). The video and delayed audio signals can be synchronized by selectively delaying the audio signal relative to a real-time radio broadcast signal, as described above in the example of FIG. 3.

At 421, the example includes monitoring a real-time audio signal for a specified audio signature. Monitoring the real-time audio signal can include using the processor circuit 213 to compare information sampled from the real-time audio signal with information from the audio signature memory circuit 212 to identify a trigger event in the real-time signal. The trigger event can be identified based on, among other things, a signal amplitude, frequency content, timing, or other characteristic. At 422, if the specified audio signature is not detected, then the real-time audio signal can continue to be monitored at 421. In an example, the real-time audio signal can be monitored or sampled periodically, such as once per second, or at some other interval. In an example, monitoring the real-time audio signal at 421 can include trending information about the audio signal to identify one or more changes in the audio signal.

At 422, if the specified audio signature is detected, then the system 200 can provide an audible or visual alert at 440. In an example, providing an audible alert at 440 includes using the speaker 260 and/or using an audio reproduction feature of the emergency alert indicator 220. In an example, providing a visual alert at 440 includes using a display feature (e.g., an LED or other display) of the emergency alert indicator 220.

At 431, the example of FIG. 4 can additionally or alternatively include monitoring a real-time signal for an EAS broadcast. At 432, if an EAS broadcast message is not received, then the real-time audio signal can continue to be monitored, such as periodically or at some other specified interval, at 431. At 432, if an EAS broadcast message is received, then the system 200 can provide an audible or visual alert at 440, such as substantially in real-time with the receipt of the EAS broadcast message. In an example, providing an audible alert at 440 includes using the speaker 260 and/or using an audio reproduction feature of the emergency alert indicator 220. In an example, providing a visual alert at 440 includes using a display feature (e.g., an LED or other display) of the emergency alert indicator 220.

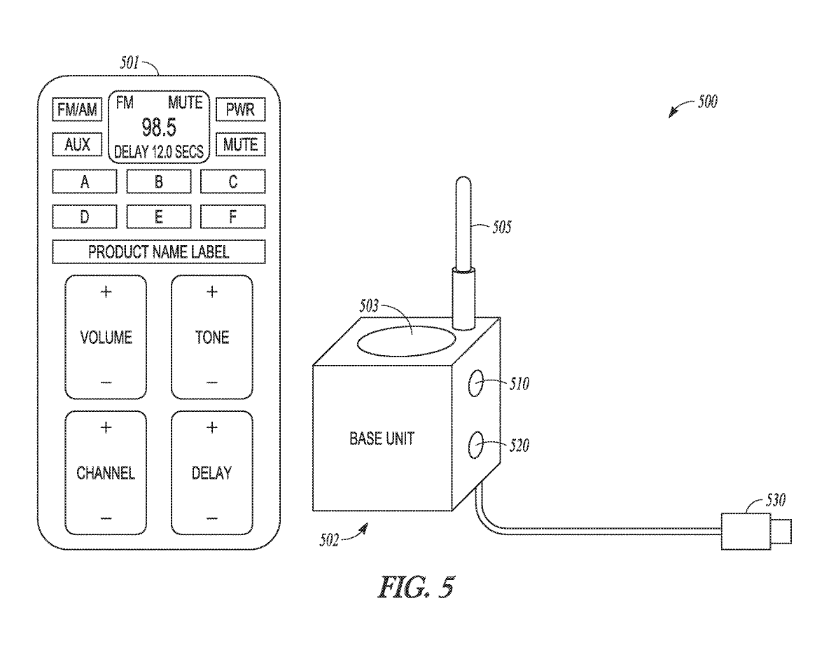

FIG. 5 illustrates generally an example of a system 500 that includes a radio receiver system 502 and a remote control 501 for interfacing with the radio receiver. The remote control 501 includes an LCD display and can be configured to provide information about, among other things, a tuned or available radio station, a delay time, an operating status or mode, and a mute status. The remote control 501 can send one or more commands to the radio receiver system 502. In an example, the remote control 501 and the receiver system 502 can use an IR interface to exchange information. The receiver system 502 can include, among other things, an AM/FM radio, audio circuitry, speaker 503, embedded microprocessor, memory, AUX input jack 510, headphone jack 520, USB power cord 530 (e.g., for power and/or data), and an antenna 505. In an example, the receiver system 502 includes the system 200, or includes one or more components thereof.

The display on the remote control 501 can include a first display item to show “AM” when the radio receiver is in AM mode, and to show “FM” when in FM mode, and to show “AUX” when in AUX mode. An “FM/AM” button can be provided to switch between the FM and AM modes, unless the AUX button has been pressed. When in AUX mode, pressing the AUX button again can disable AUX mode and return the device to FM or AM mode. In AUX mode, an external audio input 510 can be used instead of the radio receiver. In AUX mode, an EAS broadcast can be monitored using the radio receiver and reported to a listener.

In an example, an audio playback delay parameter of the receiver system 502 can be adjusted. In an example, a playback delay time can be set by a user, such as using the buttons on the remote control 501, and implemented by the receiver system 502 using an internal sample and hold circuit. In an example, the remote control 501, and optionally the receiver system 502, display information about the delay implemented by the receiver system. For example, a delay time can be displayed, such as from 0.0 to 60.0 seconds, such as in 0.1 second increments. Other delay ranges can be used.

In the example of FIG. 5, a station frequency can be adjusted using CHANNEL +/− Buttons, and the Delay Time can be adjusted using DELAY +/− Buttons. PRESET Buttons (e.g., Buttons A, B, C, D, E, F) can be used to save the channel and delay time configuration information so that it is convenient for a user to recall the same configuration information later on. In the example of FIG. 5, six profiles or sets of configuration information can be saved and later retrieved with the PRESET Buttons (Buttons A, B, C, D, E, F). When the information is retrieved (e.g., by briefly pressing a programmed PRESET Button), the remote can send a data packet to the receiver system 502. The data packet can include, for example, a packet identification code, a PRESET Number, an indication of a playback mode (e.g., FM, AM or AUX mode), a frequency code (e.g., four numbers corresponding to a tuned frequency); and a delay time parameter (e.g., corresponding to a specified delay parameter).

The preset buttons can be actuated to retrieve or set a present function. For example, when the PRESET A button is pressed briefly the “A PRESET” information is restored and codes or parameters to implement that preset are sent to or retrieved from a memory circuit in the receiver system 502. The preset buttons can be programmed by a user. For example, when pressed and held down for 2 seconds or longer, current configuration information, such as entered by user, is stored in the “A PRESET” memory. The other PRESET buttons can be similarly used and configured.

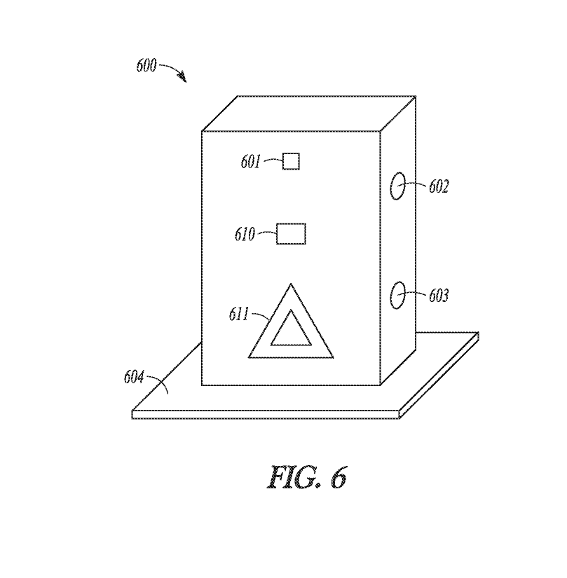

FIG. 6 illustrates generally an example of a receiver system 600 that includes a first broadcast receiver and a delay circuit. The example of FIG. 6 optionally excludes an audio amplifier and speaker, and can be used together with a powered speaker system, or other portion of an existing A/V system. By excluding an audio amplifier and speaker, the cost of the radio delay unit can be reduced.

In the example of FIG. 6, the receiver system 600 with delay circuit can receive operating instructions from an IR receiver circuit 601. An IR remote can be used to deliver the instructions, for example, as described above in the example of FIG. 5. The receiver system 600 can have an integrated antenna 604. That is, the integrated antenna 604 can optionally be built-in to some structure or feature of the receiver system 600. In the example of FIG. 6, the antenna 604 is a planar, coil-type antenna that is integrated with the base of the receiver system 600.

The receiver system 600 includes a line-in 602 or auxiliary input for receiving audio content from a non-radio signal source. The receiver system 600 includes a line-out 603 or headphone jack for providing audio content to a user. In an example, the receiver system 600 includes a Bluetooth audio input and/or output. In an example, the receiver system 600 of FIG. 6 can have a small form-factor that is about one cubic inch.

The receiver system 600 can include one or both of an early warning indicator 610 and an emergency indicator 611. The early warning indicator 610 can be used to alert a listener that a change in the real-time audio signal has occurred. In an example that includes a radio broadcast of a sporting event, a change in the real-time audio signal of the sporting event broadcast can include crowd cheering or booing noises, an elevated amplitude of a commentator's voice, a commercial, or other characteristic change in the audio signal. In an example, when the change in the real-time audio signal is detected, the early warning indicator 610 is activated (e.g., by illuminating a light or producing a sound) to notify a listener of the upcoming content. In an example, the receiver system 600 is operated according to the example of FIG. 4. If, at 422, the specified audio signature is detected, then the early warning indicator 610 can be activated.

The emergency indicator 611 can be used to alert a listener that an emergency alert was received in the real-time audio signal. When the emergency alert is received, the emergency indicator 611 is activated (e.g., by illuminating a light or producing a sound) to notify a listener of the warning. Optionally, the warning is reproduced without delay, such as by muting or further delaying the otherwise-delayed audio signal. In an example, the receiver system 600 is operated according to the example of FIG. 4. If, at 432, an EAS broadcast is received, then the emergency indicator 611 can be activated.

FIG. 7 illustrates generally an example that includes automatically synchronizing audio signals from different sources based on features of the respective audio signals. In an example, one or more of an audio waveform amplitude, frequency, or morphology characteristic can be used to identify a reference point or fiducial in each of multiple different audio signals or channels. A processor circuit (e.g., the processor circuit 213 in the example of FIG. 2) can calculate a delay and apply the calculated delay to one or more of the audio channels such that, upon playback, the one or more channels are perceived to substantially correspond in time.

FIG. 7 includes a first audio signal 710 that, in this example, corresponds to a first broadcast such as from an AM or FM radio. FIG. 7 includes a second audio signal 720 that corresponds to a second broadcast such as a television broadcast. In the example of FIG. 7, the first and second audio signals 710 and 720 correspond to the same program or event. In this example, the first audio signal 710 includes audio-only radio signal information about a baseball game, and the second audio signal 720 includes television audio signal information about the same baseball game. The baseball game occurs live, in real-time, as illustrated by the timeline 700. The first and second audio signals 710 and 720 include similar but not identical information about the baseball game, for example, because the first audio signal 710 originates from a first broadcast studio, such as using audio sourced from a first location, and the second audio signal 720 originates from a different second broadcast studio, such as using audio sourced from a different second location.

The first and second audio signals 710 and 720 can be received by a variable delay radio system, such as the system 200 of FIG. 2. For example, the first audio signal 710 can be received using AM/FM receiver 202, and the second audio signal 720 can be received using the auxiliary input 210 (e.g., coupled to a line-out on a television or other A/V receiver that is tuned to receive the second audio signal 720). In an example, the second audio signal 720 is received by a microphone that is coupled to or integrated with the variable delay radio system.

In the example of FIG. 7, a variable delay radio system can be configured to selectively apply a delay to one of the first and second audio signals 710 and 720 and then provide an audio output signal such that the delayed one of the audio signals more closely corresponds in time with the other, or non-delayed one of the audio signals. For example, the first audio signal 710 from the radio signal can be delayed and then later reproduced such that playback of the first audio signal 710 is perceived as better corresponding in time with the second audio signal 720 from the television broadcast signal.

Referring again to FIG. 7, Event A on the timeline 700 represents a first event in the baseball game, such as a hit that occurs at a time to. Audio information including the “crack” of the bat hitting the ball is similarly, but not necessarily identically, broadcast both in the first audio signal 710 and the second audio signal 720. For example, the first audio signal 710 includes first information 711 about the hit, and the second audio signal 720 includes different second information 721 about the same hit. The first audio signal 710 is broadcast subject to a first delay Δd₁ relative to the actual occurrence of the hit, or Event A (see, e.g., FIG. 1 at 107). Thus, the variable delay radio system receives, and optionally begins to reproduce, information about the hit at time ti. The second audio signal 720 is broadcast subject to a second, greater delay Δd₂ (see, e.g., FIG. 1 at 105) relative to the actual occurrence of the hit. At the variable delay radio system, corresponding information in the first and second audio signals 710 and 720 is thus effectively offset in time by a duration ΔD=Δd₂−Δd₁.

In an example, a processor circuit, such as the processor circuit 213 of FIG. 2, is configured to analyze the waveforms of the first and second audio signals 710 and 720 to identify candidate common signal features. For example, the processor circuit can be configured to identify respective signal peaks or transients in each of the audio channels to be synchronized. In response to identifying such peaks and/or transients, the processor circuit can be configured to update or adjust a delay characteristic that is applied to one or more of the audio signals. Information other than peak or transient signal information can be used, such as waveform morphology information, frequency content information, trends of time and energy values, or other information. In the example of FIG. 7, a processor circuit can be configured to use information about peaks detected at t₁ and t₂ to determine the delay ΔD, and then the processor circuit can apply the delay ΔD to the first audio signal 710. When the first audio signal 710 is reproduced with the delay ΔD, it can be perceived (e.g., at the output of the variable delay radio system) as properly corresponding in time with the second audio signal 720.

### NOTES AND EXAMPLES

Example 1 can include or use subject matter (such as an apparatus, a system, a distributed system, a method, a means for performing acts, or a device readable medium including instructions that, when performed by the device, can cause the device to perform acts), such as can include or use a device for receiving a broadcast signal and providing a delayed output that includes information from the broadcast signal. In Example 1, the receiver device includes a first radio receiver circuit configured to receive a first broadcast radio signal, and a user input configured to be adjustable by a user to provide a delay parameter. The receiver device can include an audio signal delay circuit configured to receive the first broadcast radio signal and hold the first broadcast radio signal for a specified duration corresponding to the delay parameter. In Example 1, the audio signal delay circuit can include an audio output that is configured to provide the held first broadcast radio signal, such as to an audio amplifier and/or to an external audio reproduction system. The receiver device of Example 1 can include a processor circuit configured to monitor the first broadcast radio signal for a specified event and, when the specified event is detected in the first broadcast radio signal, the processor circuit can provide a user alert substantially contemporaneously with the detection of the specified event by the processor circuit. That is, upon detection of the specified event by the processor circuit, the processor circuit can issue a user alert (e.g., using the audio output) about the detected event. In an example, the first radio receiver circuit can be configured to receive the first broadcast radio signal in an FM or AM radio frequency band.

Example 2 can include, or can optionally be combined with the subject matter of Example 1, to optionally include when the specified event is detected in the first broadcast radio signal, the processor circuit is configured to mute the held first broadcast radio signal and provide the user alert. Optionally, the processor circuit can be configured to unmute the held first broadcast radio signal after the user alert is completed.

Example 3 can include, or can optionally be combined with the subject matter of Example 1, to optionally include when the specified event is detected in the first broadcast radio signal, the processor circuit is configured to suspend and further delay the first broadcast radio signal, and provide the user alert. Optionally, the processor circuit can be configured to resume providing the held first broadcast radio signal after the user alert is completed.

Example 4 can include, or can optionally be combined with the subject matter of one or any combination of Examples 1 through 3 to optionally include the processor circuit configured to provide the user alert within 1 second or less of the detection of the specified event by the processor circuit.

Example 5 can include, or can optionally be combined with the subject matter of one or any combination of Examples 1 through 4 to optionally include the processor circuit configured to provide the user alert at the audio output.

Example 6 can include, or can optionally be combined with the subject matter of one or any combination of Examples 1 through 5 to optionally include a display, and wherein the processor circuit is configured to provide the user alert using the display. In an example, the display includes an LED and an LED control circuit, and the processor circuit is configured to provide the user alert by providing an instruction to illuminate the LED to the LED control circuit.

Example 7 can include, or can optionally be combined with the subject matter of one or any combination of Examples 1 through 6 to optionally include an audio signal input circuit configured to receive a second audio signal. In an example, the second audio signal corresponds to or originates from the same source as the first broadcast radio signal. That is, the first broadcast radio signal and the second audio signal can include information about the same event, however the first broadcast radio signal and the second audio signal may not include identical signal information. In Example 7, the processor circuit can be configured to identify timing information for at least one common signal feature in the first broadcast radio signal and the second audio signal. A signal feature can include, among other things, an amplitude, timing, or morphology feature. In Example 7, the processor circuit can be configured to compute the delay parameter using the identified timing information.

Example 8 can include, or can optionally be combined with the subject matter of one or any combination of Examples 1 through 7 to optionally include an audio output circuit configured to provide a delayed version of the first broadcast radio signal. In Example 8, the delayed version of the first broadcast radio signal can be delayed by a duration that corresponds to the computed delay parameter such that, upon playback or output, the delayed version is substantially synchronized with the second audio signal.

Example 9 can include, or can optionally be combined with the subject matter of one or any combination of Examples 1 through 8 to optionally include the processor circuit configured to monitor the first broadcast radio signal for a specified event that includes an Emergency Alert System broadcast message.

Example 10 can include, or can optionally be combined with the subject matter of one or any combination of Examples 1 through 9 to optionally include the processor circuit configured to trend information about the first broadcast radio signal to detect, as the specified event, a specified change in an amplitude or a frequency component of the signal.

Example 11 can include or use subject matter (such as an apparatus, a system, a distributed system, a method, a means for performing acts, or a device readable medium including instructions that, when performed by the device, can cause the device to perform acts), such as can include or use a receiver device for receiving a broadcast signal. In Example 11, the receiver device can include a first radio receiver circuit configured to receive a first broadcast radio signal and a user input configured to be adjustable by a user to provide a delay parameter. Example 11 includes an audio signal delay circuit configured to receive the first broadcast radio signal and hold the first broadcast radio signal for a specified duration corresponding to the delay parameter, the audio signal delay circuit including an audio output configured to provide the held first broadcast radio signal. Example 11 further includes a processor circuit configured to monitor the first broadcast radio signal for a specified audio signature and, when the specified audio signature is detected in the first broadcast radio signal, the processor circuit is configured to provide a user alert substantially contemporaneously with the detection of the specified audio signature by the processor circuit.

Example 12 can include, or can optionally be combined with the subject matter of Example 11, to optionally include the processor circuit configured to provide the user alert within 1 second of the detection of the specified audio signature by the processor circuit.

Example 13 can include, or can optionally be combined with the subject matter of one or any combination of Examples 11 or 12 to optionally include the processor circuit configured to provide the user alert at the audio output.

Example 14 can include, or can optionally be combined with the subject matter of one or any combination of Examples 11 through 13 to optionally include a display, wherein the processor circuit is configured to provide the user alert using the display.

Example 15 can include, or can optionally be combined with the subject matter of Example 14, to optionally include, as the display, an LED and an LED control circuit, and wherein the processor circuit is configured to provide the user alert by providing an instruction to illuminate the LED to the LED control circuit.

Example 16 can include, or can optionally be combined with the subject matter of one or any combination of Examples 11 through 15 to optionally include the first radio receiver circuit configured to receive the first broadcast radio signal in an FM or AM radio frequency band.

Example 17 can include, or can optionally be combined with the subject matter of one or any combination of Examples 11 through 16 to include identifying whether the audio signature includes one or more of a specified audio signal waveform shape, amplitude, frequency, or duration.

Example 18 can include or use subject matter (such as an apparatus, a system, a distributed system, a method, a means for performing acts, or a device readable medium including instructions that, when performed by the device, can cause the device to perform acts), such as can include or use a method for operating a radio device. The method of Example 18 can include receiving a broadcast audio signal using a radio receiver, and identifying whether the received broadcast audio signal includes a specified audio signal feature. In Example 18, when the received broadcast audio signal includes the specified audio signal feature, the example includes delivering information about the identified audio signal feature to a user substantially in real-time with the identification of the feature. In Example 18, when the received broadcast audio signal does not include the specified audio signal feature, the example includes adjusting a variable delay time of the broadcast audio signal to provide a delayed audio signal such that the delayed audio signal is synchronized with a video signal from an external video receiver. In Example 18, the broadcast audio signal and the video signal have a common source, and corresponding portions of the broadcast audio signal are received by the radio receiver prior to the video signal being received by the external video receiver.

Example 19 can include, or can optionally be combined with the subject matter of Example 18, to optionally include identifying whether the received broadcast audio signal includes audio information corresponding to crowd noise or radio commercial content.

Example 20 can include, or can optionally be combined with the subject matter of one or any combination of Examples 18 or 19 to include identifying whether the received broadcast audio signal includes a specified audio signal feature, including identifying whether the received broadcast audio signal includes an emergency alert from the Emergency Alert System.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

In the claims, the terms “including” and “comprising” are open-ended, that is, a system, device, article, composition, formulation, or process that includes elements in addition to those listed after such a term in a claim are still deemed to fall within the scope of that claim. Moreover, in the claims, the terms “first,” “second,” and “third,” etc. are used merely as labels, and are not intended to impose numerical requirements on their objects.

What is claimed is:

1. A receiver device for receiving a broadcast signal and providing a delayed output that includes information from the broadcast signal, the receiver device comprising:
a first radio receiver circuit configured to receive a first broadcast radio signal;
a user input configured to be adjustable by a user to provide a delay parameter;
an audio signal delay circuit configured to receive the first broadcast radio signal and hold the first broadcast radio signal for a specified duration corresponding to the delay parameter, the audio signal delay circuit including an audio output that is configured to provide the held first broadcast radio signal; and
a processor circuit configured to monitor the first broadcast radio signal for a specified event and, when the specified event is detected in the first broadcast radio signal, the processor circuit is configured to provide a user alert substantially contemporaneously with the detection of the specified event by the processor circuit.

2. The receiver device of claim 1, wherein when the specified event is detected in the first broadcast radio signal, the processor circuit is configured to mute the held first broadcast radio signal and provide the user alert.

3. The receiver device of claim 1, wherein when the specified event is detected in the first broadcast radio signal, the processor circuit is configured to suspend and further delay the first broadcast radio signal, and provide the user alert.

4. The receiver device of claim 1, wherein the processor circuit is configured to provide the user alert within 1 second or less of the detection of the specified event by the processor circuit.

5. The receiver device of claim 1, wherein the processor circuit is configured to provide the user alert at the audio output.

6. The receiver device of claim 1, further comprising a display, and wherein the processor circuit is configured to provide the user alert using the display.

7. The receiver device of claim 1, further comprising:
an audio signal input circuit configured to receive a second audio signal, the second audio signal corresponding to the same source as the first broadcast radio signal;
wherein the processor circuit is configured to identify timing information for at least one common signal feature in the first broadcast radio signal and the second audio signal; and
wherein the processor circuit is configured to compute the delay parameter using the identified timing information.

8. The receiver device of claim 7, further comprising an audio output circuit configured to provide a delayed version of the first broadcast radio signal, the delayed version being delayed by a duration corresponding to the computed delay parameter such that the delayed version is substantially synchronized with the second audio signal.

9. The receiver device of claim 1, wherein the processor circuit is configured to monitor the first broadcast radio signal for a specified event that includes an Emergency Alert System broadcast message.

10. The receiver device of claim 1, wherein the processor circuit is configured to trend information about the first broadcast radio signal to detect, as the specified event, a specified change in an amplitude or a frequency component of the signal.

11. A receiver device for receiving a broadcast signal, the receiver device comprising:
a first radio receiver circuit configured to receive a first broadcast radio signal;
a user input configured to be adjustable by a user to provide a delay parameter;
an audio signal delay circuit configured to receive the first broadcast radio signal and hold the first broadcast radio signal for a specified duration corresponding to the delay parameter, the audio signal delay circuit including an audio output configured to provide the held first broadcast radio signal; and
a processor circuit configured to monitor the first broadcast radio signal for a specified audio signature and, when the specified audio signature is detected in the first broadcast radio signal, the processor circuit is configured to provide a user alert substantially contemporaneously with the detection of the specified audio signature by the processor circuit.

12. The receiver device of claim 11, wherein the processor circuit is configured to provide the user alert within 1 second of the detection of the specified audio signature by the processor circuit.

13. The receiver device of claim 11, wherein the processor circuit is configured to provide the user alert at the audio output.

14. The receiver device of claim 11, further comprising a display, and wherein the processor circuit is configured to provide the user alert using the display.

15. The receiver device of claim 11, wherein the first radio receiver circuit is configured to receive the first broadcast radio signal in an FM or AM radio frequency band.

16. The receiver device of claim 11, wherein the audio signature includes one or more of a specified audio signal waveform shape, amplitude, frequency, or duration.

17. A method for operating a radio device, the method comprising:
receiving a broadcast audio signal using a radio receiver;
identifying whether the received broadcast audio signal includes a specified audio signal feature, and:
when the received broadcast audio signal includes the specified audio signal feature, delivering information about the identified audio signal feature to a user substantially in real-time with the identification of the feature; and
when the received broadcast audio signal does not include the specified audio signal feature, adjusting a variable delay time of the broadcast audio signal to provide a delayed audio signal such that the delayed audio signal is synchronized with a video signal from an external video receiver;
wherein the broadcast audio signal and the video signal have a common source; and
wherein corresponding portions of the broadcast audio signal are received by the radio receiver prior to the video signal being received by the external video receiver.

18. The method of claim 17, further comprising:
receiving a second audio signal corresponding to the video signal from the external video receiver, the second audio signal corresponding to the same source as the received broadcast audio signal;
identifying timing information for at least one common signal feature in the received broadcast audio signal and the second audio signal; and
computing the variable delay time using the identified timing information.

19. The method of claim 17, wherein the identifying whether the received broadcast audio signal includes a specified audio signal feature includes identifying whether the received broadcast audio signal includes audio information corresponding to crowd noise or radio commercial content.

20. The method of claim 17, wherein the identifying whether the received broadcast audio signal includes a specified audio signal feature includes identifying whether the received broadcast audio signal includes an emergency alert from the Emergency Alert System.
